(19) United States
(12) Patent Application Publication
(10) Pub. No.: US 2015/0029881 A1
(43) Pub. Date: Jan. 29, 2015

(54) CONTROLLING A USER DEVICE

(71) Applicant: Metaswitch Networks Ltd., Enfield (GB)

(72) Inventor: Piers Daniel FINLAYSON, Enfield (GB)

(21) Appl. No.: 14/340,950

(22) Filed: Jul. 25, 2014

(30) Foreign Application Priority Data
Jul. 25, 2013 (GB) 1313314.5

(51) Int. Cl. H04L 12/26

(52) U.S. Cl. CPC H04L 43/045
USPC 370/252

(57) ABSTRACT

Measures for controlling a user device in a telecommunications network, the user device including a user interface, at least a first communication client capable of communicating via a first part of the telecommunications network and a second communication client capable of communicating via a second, different part of the telecommunications network. Network conditions associated with communication via the first part of the telecommunications network using the first communication client are analysed at the user device. In response to the analysis indicating that the quality of a communication session conducted via the first part of the telecommunications network using the first communication client would be below a predetermined communication session quality threshold, the user device configures the user interface to notify the indication to a user of the user device.

### CROSS-REFERENCE TO RELATED APPLICATIONS

This application claims priority under 35 U.S.C. §119(a) to GB Patent Application No. 1313314.5, filed on Jul. 25, 2013, the entire content of which is hereby incorporated by reference.

### BACKGROUND OF THE INVENTION

1. Field of the Invention

The present disclosure relates to control of a user device. In particular, but not exclusively, the present disclosure relates to control of a user device having a user interface and at least first and second communication clients capable of communicating via first and second parts of a telecommunications network.

2. Description of the Related Technology

Voice over IP (VoIP) applications have been around for many years. Implementation and adoption was originally on desktop personal computers (PCs), using mostly Windows™, Mac™ and Linux™ operating systems. In more recent years, VoIP applications (‘apps’) have also seen growing adoption on smartphones and tablets, with iOS™ (iPhone™ and iPad™) and Android being the main supported platforms. There is now a wealth of VoIP apps, from possibly the best known, Skype™, to commercial offerings like CounterPath's Bria™ and Metaswitch's Accession™, to open source offerings such as Jitsi™ and Linphone™.

Providing acceptable voice quality when running over IP networks, is a challenge. To stream voice (and/or other media such as video) over real-time networks the following processing has to happen:
Voice has to be captured (sampled) from an audio input device on the source platform.
The sampled voice must be packetized—broken up in chunks. (How big the chunks are is called the packetization interval—and is often 20 milliseconds.)
The sampled voice must then be encoded using a codec, such as G.729, G.722 or SILK. The codec may perform some compression of the voice data, and this compression may be lossless or lossy. Some codecs purely compress the single chunk of voice, so the decode of a packet doesn't require any information other than this chunk. However, some codecs, like G.722 are “differential” codecs, and the decode operation relies on information contained in multiple packets. For these codecs, loss of a single packet impacts quality of audio encapsulated within other packets, meaning one lost packet causes greater voice quality impacts.
An IP packet is created to be sent from the source to destination with the encoded audio. This is normally encapsulated within an IP packet using the Real Time Protocol (RTP).
Optionally, additional Forward Error Correction (FEC) data is included in packets before they are sent—this is information from a previously encoded chunk of data that is essentially being duplicated, so if the previous packet got lost before it reached the destination, its data can be reconstituted (at least partially) when the destination receives the packet with FEC data.
The packet is then sent from the source to the destination.
On receipt of packets at the destination, the operations are reversed—so voice samples are retrieved and decoded from the received packets and then played out of an audio device on the destination regularly (according to the packetization interval).

There is often very complex processing on the destination to provide acceptable voice quality when network conditions are imperfect. This normally consists of at least a jitter buffer implementation. This allows the destination to cope with variations in when each packet is received. Packets are rarely received exactly the packetization interval apart due to network conditions. The variation from the expected arrival time is called jitter. A jitter buffer typically operates as follows:
Received packets are put into a buffer and the processing of the incoming packets is delayed for a certain period of time (often a multiple of the packetization interval), called jitter buffer size.
Packets are pulled out of the jitter buffer in a first in first out (FIFO) order exactly the packetization interval apart, and processed.
While this adds some delay to when the received audio is played out (latency), if network jitter is smaller than the jitter buffer size, it ensures there is always a packet ready for processing and playout, so there are no gaps in audio played out (even if a packet takes slightly longer than packetization interval to arrive), and audio is not run together (even if a packet arrives too soon).

Note that a jitter buffer is generally not the only source of latency. There can also be latency introduced by the following:
Time taken for source device to sample audio, and for the packetization, encoding and transmission to take place.
Time taken for packets to traverse network between source and destination.
Time taken for destination device to decode and playout.

There is a tradeoff to be made between ensuring jitter can be coped with, and not introducing too much latency. A jitter buffer and forward error correction cannot ‘work magic’. If too many packets go missing, or jitter in the network is too big, audio quality will be impacted by breaks (or ‘gaps’) in the audio. In practice, many jitter buffers vary in size between tens of milliseconds and a small number of hundreds of milliseconds. The bigger the jitter buffer, the greater the latency.

Some networks provide better Quality of Service (QoS), ensuring fewer packets get lost and that they arrive with less jitter than others. In general, many home and even business broadband internet services do not guarantee any particular level of QoS, and packet loss and jitter can be a significant problem impacting the quality of VoIP services.

Even more of a problem, however, is the recent trend towards wireless network connectivity—with VoIP being run over either Wi-Fi (home, business, coffee shop, etc.) or over cellular data connections, using such technologies as 3G and 4G. Due to many factors including network contention, network interference, and physical impediments to signal, packet loss and/or jitter and/or delay can all be very high on these networks.

Sometimes it simply isn't possible to provide an acceptable experience using VoIP, given the current network conditions.

### SUMMARY

According to first embodiments, there is a method of controlling a user device in a telecommunications network, the user device comprising a user interface, at least a first communication client capable of communicating via a first part of the telecommunications network and a second communication client capable of communicating via a second, different part of the telecommunications network, the method comprising, at the user device: analyzing network conditions associated with communication via the first part of the telecommunications network using the first communication client; and in response to the analysis indicating that the quality of a communication session conducted via the first part of the telecommunications network using the first communication client would be below a predetermined communication session quality threshold, configuring the user interface to notify the indication to a user of the user device.

According to second embodiments, there is apparatus for use in controlling a user device in a telecommunications network, the user device comprising a user interface, at least a first communication client capable of communicating via a first part of the telecommunications network and a second communication client capable of communicating via a second, different part of the telecommunications network, the apparatus comprising at least one processor, and at least one memory including computer program code, the at least one memory and the computer program code being configured to, with the at least one processor, cause the user device to: analyses network conditions associated with communication via the first part of the telecommunications network using the first communication client; and in response to the analysis indicating that the quality of a communication session conducted via the first part of the telecommunications network using the first communication client would be below a predetermined communication session quality threshold, configure the user interface to notify the indication to a user of the user device.

According to third embodiments, there is a computer program product comprising a non-transitory computer-readable storage medium having computer readable instructions stored thereon, the computer readable instructions being executable by a computerized device to cause the computerized device to perform a method of controlling a user device in a telecommunications network, the user device comprising a user interface, at least a first communication client capable of communicating via a first part of the telecommunications network and a second communication client capable of communicating via a second, different part of the telecommunications network, the method comprising, at the user device: analyzing network conditions associated with communication via the first part of the telecommunications network using the first communication client; and in response to the analysis indicating that the quality of a communication session conducted via the first part of the telecommunications network using the first communication client would be below a predetermined communication session quality threshold, configuring the user interface to notify the indication to a user of the user device.

According to fourth embodiments, there is a method of controlling a user device in a telecommunications network, the user device comprising a user interface, at least a first communication client capable of communicating via a first part of the telecommunications network and a second communication client capable of communicating via a second, different part of the telecommunications network, the method comprising, at a network node: analyzing network conditions associated with communication via the first part of the telecommunications network using the first communication client; and in response to the analysis indicating that the quality of a communication session conducted via the first part of the telecommunications network using the first communication client would be below a predetermined communication session quality threshold, transmitting configuration data to the user device, the configuration date being operable to control the user device to configure the user interface to notify the indication to a user of the user device.

Further embodiments comprise application software for a mobile telephony device configured to perform the method of the first embodiments. Yet further embodiments comprise a mobile telephony device with the application software of the further embodiments installed thereon.

Embodiments comprise a computer program product comprising a non-transitory computer-readable storage medium having computer readable instructions stored thereon, the computer readable instructions being executable by a computerized device to cause the computerized device to perform a method according to the fourth embodiments.

Further features will become apparent from the following description of preferred embodiments, given by way of example only, which is made with reference to the accompanying drawings.

### BRIEF DESCRIPTION OF THE DRAWINGS

FIG. 1 shows a telecommunications network according to one or more embodiments of the present invention; and

FIG. 2 shows a user device according to one or more embodiments of the present invention.

### DETAILED DESCRIPTION OF CERTAIN INVENTIVE EMBODIMENTS

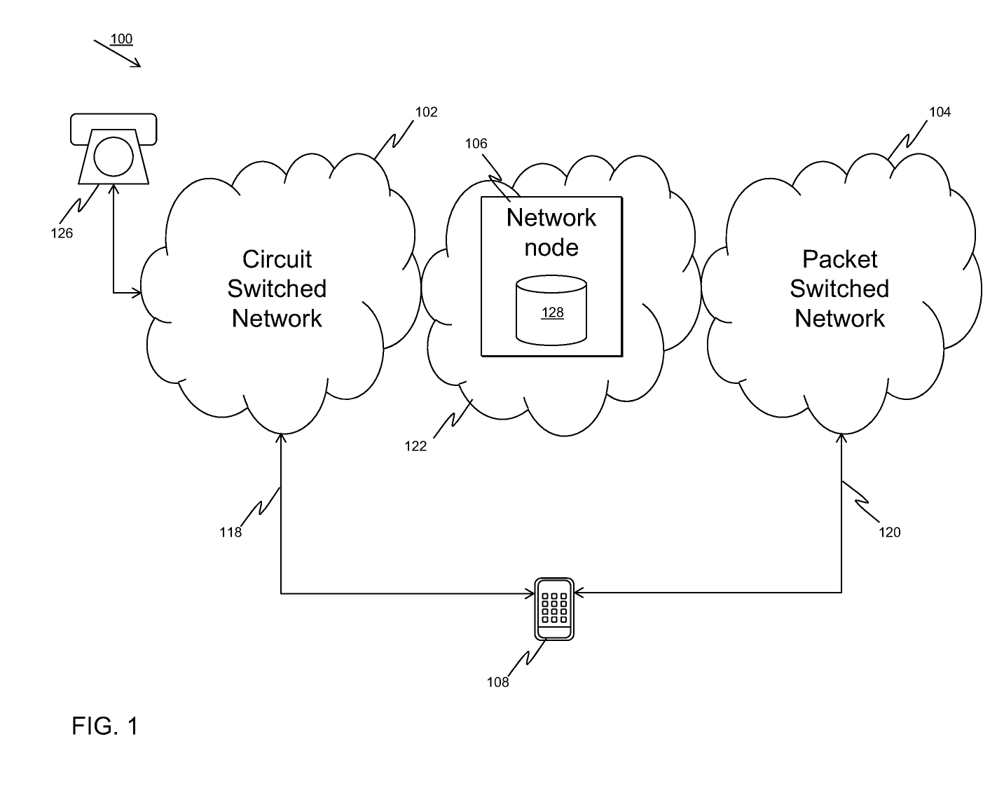

FIG. 1 shows an example telecommunications network 100 in which embodiments of the present disclosure can be employed. Telecommunications network 100 includes a circuit-switched telecommunications network part 102, a packet-switched network part 104, and may include one or more other network parts (122) and associated gateways (not shown) for linking there-between. Network parts 122 are depicted as including a network node 106 with a database 128, although network node 106 may alternatively be located within circuit-switched telecommunications network part 102 or packet-switched network part 104. Network node 106 may comprise a server, softswitch, call agent or other such network node located in the network.

A user has an associated user device 108 (or ‘endpoint device’ or ‘user equipment’) through which they may conduct communication sessions (or ‘calls’ or ‘media sessions’) with a user device 126 of a remote party. User device 108 may for example comprise a desk phone, a mobile (or ‘cellular’) telephone, a tablet and/or a personal computer.

User device 108 is equipped with one or more interfaces and one or more communication clients for conducting communications in telecommunications network 100. A user device equipped with a circuit-switched interface and communication client is adapted to conduct communications in telecommunications network 100 via link 118 with circuit-switched network 102. The circuit-switched interface may comprise a landline PSTN interface in the case of a fixed-line device such as a desk phone, or a cellular radio telephony interface in the case of a mobile device such as a mobile telephone. A user device equipped with a packet-switched interface and communications client is adapted to conduct communications in telecommunications network 100 via link 120 with packet-switched network 104. The packet-switched interface could comprise a wired interface to the internet in the case of a fixed line device such as a personal computer, or a wireless interface (e.g. Wi-Fi, Bluetooth, 3G-LTE, WiMax, etc.) to the internet in the case of a mobile device such as a tablet. The packet-switched interface may comprise an Ethernet part.

Some communication devices may be equipped with multiple communication clients. For example, in addition to the aforementioned circuit-switched communication client and associated interface, user device 108 may also be equipped with one or more packet-switched communications clients and interfaces for conducting communications with packet-switched network 104 via link 120. In this case, the multiple communication clients equipped on user device 108 may be referred to as co-located communication clients, i.e. multiple communication clients on a single device.

A communication session between a communication client on user device 108 and a communication client on a device of a remote party 126 can be routed between circuit-switched network 102 via link 118. Similarly, communication sessions can be routed between packet-switched network 104 via link 120. Circuit-switched network 102, packet-switched network and other networks 122 may comprise one or more gateway or session border controller entities (not shown) which carry out conversion between the various protocols and data formats used to transfer media data and signaling data in the different networks making up telecommunications network 100. For example, a media gateway (not shown) may convert between the different protocols of media data passing between circuit-switched network 102 and packet-switched network 104, such as packetized Voice over Internet Protocol (VoIP) data into Time-Division-Multiplexing (TDM) voice data and vice versa. A signaling gateway (not shown) may convert between the different protocols of signaling information passing between circuit-switched network 102 and packet-switched network 104, such as Session Initiation Protocol (SIP), Signaling System 7 (SS7), Integrated Services Digital Network User Part (ISUP), American National Standards Institute (ANSI)—41, Mobile Application Part (MAP) formats, etc.

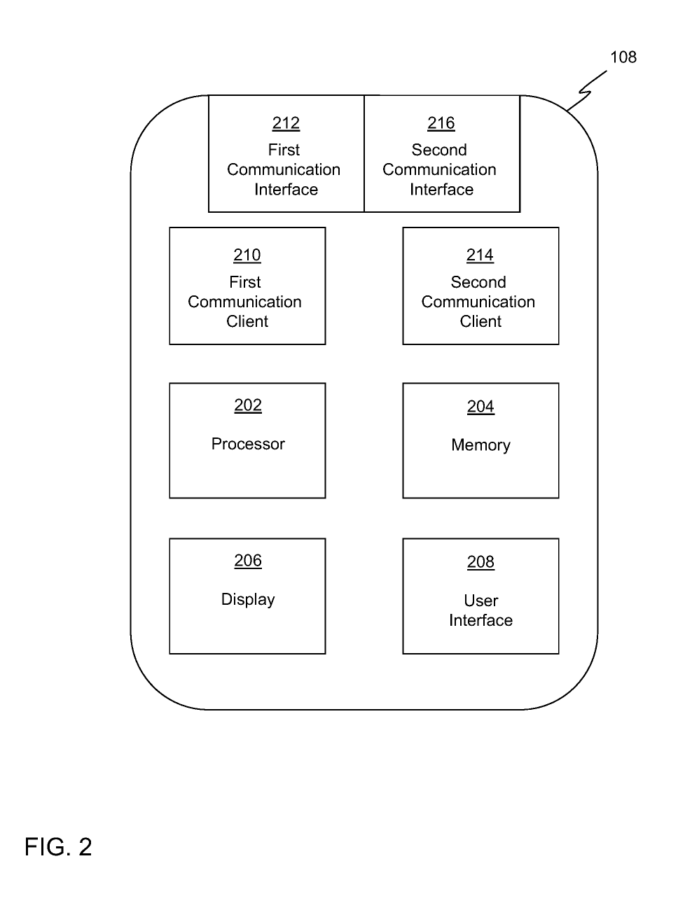

FIG. 2 shows an example user device 108 adapted to conduct communication sessions such as voice or video calls in telecommunication network 100 according to embodiments.

User device 108 comprises a processor 202 for carrying out data processing tasks of embodiments. User device 108 comprises a memory 204 for storing data associated with embodiments. User device 108 comprises a user interface 208 for collecting user input from a user of the device, including user input associated with setting up and acceptance of communication sessions, such as telephone dialing number digits or incoming call acceptance or rejection commands. In embodiments, communication device 108 comprises a display 206. In some embodiments, user interface 208 may comprise a touch-screen layer overlaying display 206, upon which one or more touch-sensitive screen regions (or ‘buttons’) are configurable by processor 202.

User device 108 comprises a first communication client 210 adapted to communicate via a first part of telecommunications network 100 via a first communication interface 212. In some embodiments, first communication client 210 comprises a packet-switched communication client adapted to communicate via a packet-switched part 104 of telecommunications network 100. In some such embodiments, first communication interface 212 is a packet-switched communication interface.

In embodiments, user device 108 also comprises a second communication client 214 adapted to communicate via a second, different part of telecommunications network 100 via a second communication interface 216. In some embodiments, second communication client 214 comprises a circuit-switched communication client adapted to communicate via a circuit-switched part 102 of telecommunications network 100. In such embodiments, second communication interface 216 is a circuit-switched communication interface. In such embodiments, first communication client 210 and second communication client 214 are described as being co-located on user device 108.

Embodiments comprise measures, including methods, apparatus and computer software for controlling a user device 108 in a telecommunications network 100, the user device comprising a user interface 208, at least a first communication client 212 capable of communicating via a first part of the telecommunications network and a second communication client 216 capable of communicating via a second, different part of the telecommunications network.

Network conditions associated with communication via the first part of the telecommunications network using the first communication client are analyzed at the user device. In response to the analysis indicating that the quality of a communication session conducted via the first part of the telecommunications network using the first communication client would be below a predetermined communication session quality threshold, the user device configures the user interface to notify the indication to a user of the user device.

Some embodiments involve using network condition analysis to decide whether to allow the user to make or receive a VoIP call as usual, or to allow calls to be made using another mechanism.

In embodiments, the configuring comprises configuring the user interface to give the user the option of conducting a communication session via the second part of the telecommunications network using the second communication client. For example in embodiments where user interface 208 comprises a touch-screen user interface, a touch-sensitive screen region (or ‘button’) may be configured which is operable, in response to receiving appropriate user input, initiate conducting of a communication session via the second part of the telecommunications network using the second communication client.

Embodiments comprise determining that the user of the user device wishes to conduct a communication session via the first part of the telecommunications network using the first communication client; in such embodiments, the analysis is carried out in response to the determination.

In embodiments, the determination comprises detecting user input via the user interface associated with the user wishing to initiate an outgoing communication session request from the user device or wishing to accept an incoming communication session request to the user device.

In embodiments, the determination is carried out on the basis of the user of the device opening application software associated with the first communication client or opening a dialer application via the first communication client.

Embodiments comprise detecting current network conditions associated with communication via the first part of the telecommunications network using the first communication client; in such embodiments, the analysis comprises analyzing the detected current network conditions.

Embodiments comprise conducting a network test of the first part of the telecommunications network using the first communication client; in such embodiments, the detection of current network conditions is carried out at least on the basis of the conducted network test.

Embodiments comprise conducting network tests of the first part of the telecommunications network using the first communication client at a periodic interval; in such embodiments, the detection of current network conditions is carried out at least on the basis of the periodic conducted network tests.

In embodiments, the analysis comprises analyzing previous network conditions of the first part of the telecommunications network. Embodiments may comprise storing data associated with previous network conditions of the first part of the telecommunications network; in such embodiments, the analysis comprises analyzing the stored data associated with previous network conditions of the first part of the telecommunications network. In some embodiments, the data is stored at the user device (for example in memory 204), whereas in other embodiments, the stored data is stored at a network node 106 (for example in database 128).

In embodiments, the stored data comprises data associated with one or more of the following:

a location of the user device,

a time of day or day of week,

an operator of the first part of the telecommunications network,

a type of the first part of the telecommunications network,

an identifier for the first part of the telecommunications network, and

a type of network test data.

The above stored data may for example be referred to as network attributes.

Embodiments comprise receiving, via the network, data associated with previous network conditions of the first part of the telecommunications network; in such embodiments, the analysis comprises analyzing the received data associated with previous network conditions of the first part of the telecommunications network.

Embodiments comprise transmitting, via the network, data associated with current and/or previous network conditions of the first part of the telecommunications network. The transmitted data may be transmitted to one or more other user devices or a network node.

In embodiments, the configuring comprises configuring the user interface to prevent the user from conducting a communication session via the first part of the telecommunications network using the first communication client until such time that the analysis indicates that the quality of a communication session conducted via the first part of the telecommunications network using the first communication client would be above the predetermined communication session quality threshold.

In embodiments, the first communication client and the second communication client are associated with different radio access technologies.

In embodiments, the first part of the telecommunications network comprises a packet-switched part 104 of the telecommunications network.

In embodiments, the first part of the telecommunications network comprises a wireless local area network (WLAN).

In embodiments, the first part of the telecommunications network comprises a circuit-switched part 102 of the telecommunications network.

Telecommunications network 100 may itself comprise multiple telecommunications networks which may for example be provided by different operators. The first and second parts of telecommunications network 100 may therefore be located within different telecommunications networks. For example, in embodiments where the first network part comprises a packet-switched network or WLAN and the second network part comprises a circuit-switched network, the packet-switched network or WLAN may well not be part of the same telecommunications network as the circuit-switched network.

In embodiments, the second part of the telecommunications network comprises a cellular network.

In embodiments, the first communication client comprises Voice over Internet Protocol (VoIP) application software.

Embodiments comprise measures, including methods, apparatus and computer program products for use in controlling a user device in a telecommunications network, the user device comprising a user interface, at least a first communication client capable of communicating via a first part of the telecommunications network and a second communication client capable of communicating via a second, different part of the telecommunications network. Network conditions associated with communication via the first part of the telecommunications network using the first communication client are analyzed at a network node 106. In response to the analysis indicating that the quality of a communication session conducted via the first part of the telecommunications network using the first communication client would be below a predetermined communication session quality threshold, the network node transmits configuration data to the user device, the configuration date being operable to control the user device to configure the user interface to notify the indication to a user of the user device.

In example embodiments described below, the first communication client comprises VoIP application software and is referred to as a VoIP application. However, alternative embodiments may involve the first communication client comprising non-VoIP application software.

Network condition analysis may be performed in a number of different ways, for example periodically, before call, during a call, and/or after call

In embodiments involving periodic network condition analysis, the VoIP application periodically sends a test stream of IP/RTP packets to a server. Each packet is instrumented by the VoIP application before sending with the send time. This server then adds its own instrumentation to the packets (information about when each packet was received) and returns (echoes) the packets back to the VoIP application. While the test stream of packets is designed to look like encoded voice media, and in particular packets are the correct size and format to be voice media, and are sent with an appropriate packetization interval, the payload actually contains the instrumentation, to ensure it makes it through the network without being modified, as other elements of the packet, for example IP headers, may be.

The VoIP application processes the returned data stream, and may determine information including the following:
How long each packet took to arrive at the server.
Average time for packet to arrive at the server.
Average, minimum and maximum jitter of packets received at server.
The above data for packets travelling from the server to the client.
Effective bandwidth seen in each direction—if effective bandwidth was below that required for the packet stream. This is calculated by seeing whether time for packet to traverse network steadily increases with each subsequent packet, suggesting packets are queued due to insufficient bandwidth.
Predicted Mean Opinion Score (MOS score, a way of quantifying voice quality) for a call made over these conditions, by known methods using the other data collected.

The server may be located anywhere, but for best results it is co-located with any other infrastructure used by the service provider for calls, to ensure network conditions for the usual call path are tested. In practice the location is not that important, as it is the access leg (e.g. the home broadband, or cellular data connection, or Wi-Fi network) that tends to impair performance the most, so as long as the server is behind all of these from the VoIP app's perspective, the results will be useful.

Sending and receiving data is an expensive operation for smartphones and tablets in terms of battery life impacts; the more a device wakes its wireless (Wi-Fi or cellular data) radios up, the bigger the battery drain. The VoIP app therefore normally times its network testing to happen when itself or another app on the device is already using the radio. For example, if the VoIP app is using SIP signaling and is periodically sending SIP REGISTER messages, it does network condition testing at the same time.

The length of the network test can be optimized to save battery life as follows:
By viewing and analyzing multiple network tests, operators can conclude that a test of a certain length shows no more useful information than the first period of the same test. The operator can then configure the VoIP app network test lengths to a shorter length.
The application can analyses its network test history to the same end. For example, if the first x seconds of tests tend to show the same results as the subsequent y seconds, the tests can be shortened.

The VoIP app can also be configured to the run network tests at a certain periodicity, to reduce battery life impacts, or network data usage.

The VoIP app may also runs network tests whenever it detects a network change—e.g. when the smartphone switches from cellular data to Wi-Fi and back again.

Results from these tests can be stored in the VoIP app and/or transmitted and stored in a network node 106, which collects results from a plurality of VoIP apps. Additional information can be stored along with the test results including for example:
Location
Time of day, day of week.
Network type (WLAN such as Wi-Fi, or cellular)
If cellular network, which network (e.g. EE™, O2™, Vodafone™)
If cellular network, what type of cellular data (EDGE, 3G, 4G)
If Wi-Fi network, what sort of Wi-Fi (e.g. 802.11b, g, n, ac, etc.)
If Wi-Fi, and if determinable what operator's Wi-Fi (e.g. coffee shop, home, etc.). (There are a number of ways of determining this—for example Wi-Fi service set identifier (SSID), location, or public IP address used by the access point.)

In embodiments involving before call network condition analysis, when the VoIP application detects that a user is about to make a call, it can run a network test to ensure network conditions are sufficient/adequate/acceptable for a call. The network test follows the same approach as in the section above. However, there are some particular considerations:
The test run should be shorter than is likely used to run periodically, as any call will likely be delayed until the test has run.
The app predicts when the user is likely to make a call, and runs the test when it predicts the user is about to make a call—to give it sufficient time for a test to run. The VoIP app predicts the user is about to make a call in a number of ways:
When the application is brought from the background to the foreground—e.g. the user has started using the app, a test is run.
If the dialer screen is brought up in the application a test is run.

If a call is ultimately not made, this information is stored as described in the periodic testing case. If a call is made, the information is typically stored after the call as described below.

In embodiments involving during call network condition analysis, during a call there is no need to run network tests to determine the network conditions, as media streams are running in both directions. The VoIP app can therefore use the properties of the received media stream to determine the conditions from the other end to it. It can use other feedback mechanism such as the Real Time Control Protocol (RTCP) to receive information from the other end of the call about what network conditions it has seen.

A similar set of data is analyzed as described in the period network testing above, to determine for example:
Latency
Max, min, average, jitter
Effective bandwidth, if insufficient.
Predicted MOS score

Information about network conditions is typically stored after a call.

In embodiments involving after call network condition analysis, testing typically isn't performed after a call, unless covered by one of the previous cases described above. However, if a call has been made, any information collected before that call and during that call can be stored. The VoIP app may wait until after the call to store the data to:
store all of the information (rather than information about a partial call)
avoid impacting the network and/or device CPU while a call is in progress and potentially impacting call quality.

In embodiments, network condition analysis data is stored. In some embodiments the test data is stored within the VoIP application, either in random access memory (RAM) or in persistent storage on the user device. The application will typically age out old information to ensure the storage doesn't fill up. The test data is stored in a network node 106 (e.g. a server) in the network, either in RAM or persistent storage 128, along with a device or subscriber identifier. Information may or may not be aged out depending on available storage.

Embodiments comprise network condition analysis. By periodically analyzing the historical stored network condition test results, the VoIP application, or a network nodes, can produce rules which the VoIP app follows to decide whether to:
Not inform the user of any potential network condition impacts (for example if the conditions are considered to be good).
Inform the user that network quality may be bad, based on historical information, and either give them the option of making the call using another mechanism, or even preventing them from making a VoIP call.
Inform the user that network quality may be bad based on a pre-call test, and offering the user a choice, or preventing them from making a call.

There are choices in the User Experience (UX) the VoIP app provides in these cases. Some operators may want to give the user a choice of whether to use VoIP even if quality is bad, and others may want not give the user a choice.

Some example ways the application may decide that quality is likely to be bad (e.g. used as a predetermined communication session quality threshold) include the following:
If more than a configured threshold percentage of network tests using a particular cellular provider (e.g. Vodafone), connection type (e.g. 3G) from a particular location (Enfield, EN2 postcode), during rush hour (8-9am, 4-6pm) give a predicted MOS score lower than a certain configured percentage.
If a pre-call test indicates that the MOS score is lower than a certain configured percentage (or other such predetermined threshold).

Embodiments comprise sharing data between VoIP applications on different user devices, for example sharing network condition history with other VoIP application instances, either directly (for example peer to peer) or by uploading results to a network node (e.g. a server platform) that analyses the results and configures applications with rules.

As described above, the VoIP application may upload its network condition history to a central network node (such as a server or group of servers) for wider processing, and the network node may subsequently configure VoIP apps on various user devices with new policies. If the VoIP infrastructure uses a peer to peer model, network condition history may be shared directly between VoIP apps.

Some embodiments comprise detecting when network conditions are insufficient to provide satisfactory voice quality, both dynamically detecting current network conditions, and analyzing previous conditions based on current network (e.g. cellular data or Wi-Fi), network type (if cellular data 3G or 4G), location (for example a coffee shop on a certain street in a certain town in the UK) and time of day (for example, at lunchtime) to predict what network conditions are likely to be

Some embodiments involve indicating to the user that voice quality of a VoIP call is insufficient, and allowing the user to use another mechanism to make or receive their call, for example using a smartphone's cellular dialer, or a Plain Old Telephony System (POTS) phone.

The above embodiments are to be understood as illustrative examples of the present disclosure. Further embodiments are envisaged.

For example, it is not just calls the user makes that can be affected by embodiments as described above. For inbound calls the VoIP app may choose to recommend (or force) the user to take the call a different way, for example by forwarding the call to the cellular phone, or another phone nearby.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of embodiments, which is defined in the accompanying claims.

What is claimed is:

1. A method of controlling a user device in a telecommunications network, the user device comprising a user interface, at least a first communication client capable of communicating via a first part of the telecommunications network and a second communication client capable of communicating via a second, different part of the telecommunications network, the method comprising, at the user device:
analyzing network conditions associated with communication via the first part of the telecommunications network using the first communication client; and
in response to the analysis indicating that the quality of a communication session conducted via the first part of the telecommunications network using the first communication client would be below a predetermined communication session quality threshold, configuring the user interface to notify the indication to a user of the user device.

2. A method according to claim 1, wherein the configuring comprises configuring the user interface to give the user the option of conducting a communication session via the second part of the telecommunications network using the second communication client.

3. A method according to claim 1, comprising determining that the user of the user device wishes to conduct a communication session via the first part of the telecommunications network using the first communication client,
wherein the analysis is carried out in response to the determination.

4. A method according to claim 3, wherein the determination comprises detecting user input via the user interface associated with the user wishing to initiate an outgoing communication session request from the user device or wishing to accept an incoming communication session request to the user device.

5. A method according to claim 3, wherein the determination is carried out on the basis of the user of the device opening application software associated with the first communication client or opening a dialler application via the first communication client.

6. A method according to claim 1, comprising detecting current network conditions associated with communication via the first part of the telecommunications network using the first communication client,
wherein the analysis comprises analysing the detected current network conditions.

7. A method according to claim 6, comprising conducting a network test of the first part of the telecommunications network using the first communication client,
wherein the detection of current network conditions is carried out at least on the basis of the conducted network test.

8. A method according to claim 6, comprising conducting network tests of the first part of the telecommunications network using the first communication client at a periodic interval,
wherein the detection of current network conditions is carried out at least on the basis of the periodic conducted network tests.

9. A method according to claim 1, wherein the analysis comprises analysing previous network conditions of the first part of the telecommunications network.

10. A method according to claim 9, comprising storing data associated with previous network conditions of the first part of the telecommunications network,
wherein the analysis comprises analyzing the stored data associated with previous network conditions of the first part of the telecommunications network.

11. A method according to claim 10, wherein the stored data comprises data associated with one or more of the following:
a location of the user device,
a time of day or day of week,
an operator of the first part of the telecommunications network,
a type of the first part of the telecommunications network,
an identifier for the first part of the telecommunications network, and
a type of network test data.

12. A method according to claim 9, comprising receiving, via the network, data associated with previous network conditions of the first part of the telecommunications network,
wherein the analysis comprises analyzing the received data associated with previous network conditions of the first part of the telecommunications network.

13. A method according to claim 1, comprising transmitting, via the network, data associated with current and/or previous network conditions of the first part of the telecommunications network.

14. A method according to claim 13, wherein the transmitted data is transmitted to one or more other user devices or a network node.

15. A method according to claim 1, wherein the configuring comprises configuring the user interface to prevent the user from conducting a communication session via the first part of the telecommunications network using the first communication client until such time that the analysis indicates that the quality of a communication session conducted via the first part of the telecommunications network using the first communication client would be above the predetermined communication session quality threshold.

16. A method according to claim 1, wherein the first communication client and the second communication client are associated with different radio access technologies, and/or
the first communication client comprises Voice over Internet Protocol (VoIP) application software.

17. A method according to claim 1, wherein the first part of the telecommunications network comprises a packet-switched part of the telecommunications network, and/or
the first part of the telecommunications network comprises a wireless local area network (WLAN), and/or
the second part of the telecommunications network comprises a circuit-switched part of the telecommunications network, and/or
the second part of the telecommunications network comprises a cellular network.

18. A system for use in controlling a user device in a telecommunications network, the user device comprising a user interface, at least a first communication client capable of communicating via a first part of the telecommunications network and a second communication client capable of communicating via a second, different part of the telecommunications network, the system comprising:
at least one processor; and
at least one memory including computer program code, the at least one memory and the computer program code being configured to, with the at least one processor, cause the user device to:
analyze network conditions associated with communication via the first part of the telecommunications network using the first communication client; and
in response to the analysis indicating that the quality of a communication session conducted via the first part of the telecommunications network using the first communication client would be below a predetermined communication session quality threshold, configure the user interface to notify the indication to a user of the user device.

19. A non-transitory computer-readable storage medium having computer-executable instructions stored thereon, which, when executed by a processor, cause a computerized device to perform a method of controlling a user device in a telecommunications network, the user device comprising a user interface, at least a first communication client capable of communicating via a first part of the telecommunications network and a second communication client capable of communicating via a second, different part of the telecommunications network, the method comprising, at the user device:
analyzing network conditions associated with communication via the first part of the telecommunications network using the first communication client; and
in response to the analysis indicating that the quality of a communication session conducted via the first part of the telecommunications network using the first communication client would be below a predetermined communication session quality threshold, configuring the user interface to notify the indication to a user of the user device.

20. A method of controlling a user device in a telecommunications network, the user device comprising a user interface, at least a first communication client capable of communicating via a first part of the telecommunications network and a second communication client capable of communicating via a second, different part of the telecommunications network, the method comprising, at a network node:
analyzing network conditions associated with communication via the first part of the telecommunications network using the first communication client; and
in response to the analysis indicating that the quality of a communication session conducted via the first part of the telecommunications network using the first communication client would be below a predetermined communication session quality threshold, transmitting configuration data to the user device, the configuration data being operable to control the user device to configure the user interface to notify the indication to a user of the user device.
